(19) United States
(12) Patent Application Publication
(10) Pub. No.: US 2015/0208195 A1
(43) Pub. Date: Jul. 23, 2015

(54) METHOD AND APPARATUS FOR OUT OF BAND LOCATION SERVICES

(71) Applicant: Alexander V. Kariman, Rockville, MD (US)

(72) Inventor: Alexander V. Kariman, Rockville, MD (US)

(73) Assignee: SAFE FRONTIER LLC, McLean, VA (US)

(21) Appl. No.: 14/158,932

(22) Filed: Jan. 20, 2014

(51) Int. Cl. H04W 4/02

(52) U.S. Cl. CPC H04W 4/02

(57) ABSTRACT

The present disclosure provides method and apparatus for facilitating persistent Location-Based Services. According to one aspect of the present invention, there is a method and apparatus for facilitating acquisition and transmission of location-based data out-of-band, regardless of the operability of the main electronic circuitry of an electronic device.

### FIELD OF THE INVENTION

The present invention generally relates to electronic devices and methods for providing geographical location information. Such devices include but not limited to electronic devices of all form-factors: personal computers, servers, mobile computing devices, including phones, tablets, digital assistants, scanners, and the like. It also relates to embedded systems (including integrated systems and real-time systems). Such embedded systems include, but not limited to: industrial equipment, micro and macro embedded systems, intelligent meters, controllers, network-ware, embedded automotive, marine, and aerospace systems, POS and retail equipment, ATM and banking, digital signage, entertainment systems, gaming systems, surveillance, infotainment, medical systems, critical embedded systems, household and office-use embedded systems, recreational and educational embedded systems, embedded systems equipped with a radio module, including cellular radio, embedded systems used in automation equipment, energy, mining, special and general purpose embed systems, and the like.

### BACKGROUND

Increasing number of mobile electronic devices are able to determine self-geographic location using GPS or other geo-positioning technologies. Modern electronic devices have a high degree of self-awareness with respect to their location. This allows for not only creation of new functionality but also delivery of essential location based services.

Many electronic devices include Location-Based Service (LBS) applications, which obtain geographic or network location of an electronic device from a network or an internal geo-positioning system. Such information can be displayed on a screen or transmitted to a website. LBS applications are used for navigation, asset tracking, land marking, safety, etc. Location-Based Services are important for many industries, but particularly important for the transportation industry. LBS can be employed to aid in transportation safety, provide navigation assistance, help manage logistics, and perform other important tasks.

On the other end of the spectrum are consumers and businesses that also need reliable and persistent LBS. For example, they need to track and prevent theft of electronic equipment, such as laptops and phones; provide services, such as automotive fleet tracking, cargo tracking, and help controlling access to assets based on their location, etc. Another important area of LBS application is tracking and securing network-enabled embedded devices. One of the limiting factors of proliferation of the Internet-enabled embedded devices is the lack of cost-efficient, robust security controls to provide sufficient security in the context of the emerging use-models—persistent LBS plays here an important role.

While the use-cases vary widely, as well as implementations of location detection systems and underlain technologies, one issue remains—implementing LBS with enhanced operational reliability and persistence; particularly, in resource constrained systems, without relying on redundant standalone electronics, such as an electronic positioning tag, whether due to the cost constrains or computing resource constrains, or when greater persistence and security is desired.

One consequence of this inscrutability is that providing persistent LBS oftentimes requires installing additional controls that are bulky, expensive, and often resource consuming. Conventional LBS-enabled systems have a major drawback that if the system's main electronics are powered off or the operating system (or LBS related executable code) hung or crashed, or obstructed, LBS services would be no longer available. While some LBS-enabled systems provide additional controls enhancing the reliability and persistence, they still depend on the same set of electronics and software used to operate the system. An example could be a personal computer equipped with GPS receiver, and network software stack executed in the OS that facilitates the geo-location data acquisition and transmission from the GPS receiver to a remote website. If the Operating System (OS) crashes, the location-data will no longer be available. Therefore, additional integrated out-of-band controls are required to provide secure and persistent LBS, both for local use and use by a remote system.

A variety of persistent location tracking and security systems are known. Most of them, however, primarily address electronic device theft with the executable code residing in the firmware, which to some degree guarantees the persistence. For example, as described in the U.S. Pat. No 7,590,837 B2 (Publication date Sep. 15, 2009), the invention provides electronic device security and tracking system and method. The system includes hardware, software and firmware components that interoperate to allow tracking, disabling, and other interaction with a stolen electronic device. Another invention, the U.S. Pat. No 7,945,709 B2 (Publication date May 17, 2011) in essence describes a system for locating and monitoring electronic devices utilizing a security system that is secretly and transparently embedded within the computer. This security system causes the client computer to periodically and conditionally call a host system to report its serial number and caller ID to determine the physical location of the client computer. Another invention, the U.S. Pat. No. 8,418,226 B2 (Publication date Apr. 9, 2013) in essence describes a tamper resistant servicing agent that among other things provides location tracking and comprises of multiple functional modules residing in software and firmware. Another invention, the U.S. Pat. No 5,715,174 A (Publication date Feb. 3, 1998) in essence describes a method and apparatus with an integral security system for sending signals to a remote station enabling, among other things, device tracking and may be placed at a location not normally accessible by the operating software. Another invention, the U.S. Pat. No 6,244,758 B1 (Publication date Jun. 12, 2001) in essence describes a system for locating and monitoring electronic devices utilizing a security system that is secretly and transparently embedded within the software, firmware, or hardware of a computer. Another disclosure, the U.S. application Ser. No. 13/422,001 (Publication date Sep. 19, 2013) in essence describes mobile communication device and method for providing positioning information. Another invention, the U.S. Pat. No 7,248,880 B2 (Publication date Jul. 24, 2007) in essence describes a system for determining location of a device connected to an IP network that may determine a location identifier, where a location identifier may be associated with a geographic location of the device. Another disclosure, the EP Application No 20120360005 (Publication date Jul. 31, 2013) in essence describes a method of tracing a mobile wireless communication device geographic location in a wireless telecommunications network, and a method of notifying a mobile wireless communication device tracing unit of a mobile device geographic location. Another invention, the U.S. Pat. No 5,565,858 A (Publication date Oct. 15, 1996) in essence describes an electronic inventory tracking system for stacked containers using an electronic tag that is capable of generating and communicating location data. Another invention, the U.S. Pat. No 5,225,842 A (Publication date Jul. 6, 1993) in essence describes a tracking system employing GPS to provide accurate positioning of an object. Another invention, the U.S. Pat. No. 6,331,825 B1 (Publication date Dec. 18, 2001) in essence describes a mobile locator system which employs pager and cellular communication, and provides user interface through a network such as the Internet. Another invention, the U.S. Pat. No. 6,421,001 B1 (Publication date Jul. 16, 2002) in essence describes an object locator system for requesting and obtaining information about the location of a moveable object, having attached an object locator with GPS. Another invention, the CA Pat. No 2447401 C (Publication date Jan. 3, 2012) in essence describes a tracking system and method for locating a vehicle and/or asset, and includes an inertial navigation device generating a position vector used to determine an absolute vehicle/asset location, and includes a radio transmitter connected to the navigation device for transmitting the position vector to a central monitoring station. Another invention, the U.S. Pat. No. 5,748,147 A (Publication date May 5, 1998) in essence describes a secure, portable position locating radio that has a geo-location receiver providing local position and a local transceiver for sending local position information to a communication system and a crypto unit. Another invention, the U.S. Pat. No 6,121,922 A (Publication date Sep. 19, 2000) in essence describes a tracking system that uses a miniaturized geographic position determination and communications module, enabling the enclosure to be hidden in very small spaces, including personal concealment. Another invention, the U.S. Pat. No. 5,588,005 A (Publication date Dec. 24, 1996) in essence describes asset tracking that involves communication between a central station and the individual tracking units, where there is a primary communication link for tracking the assets and a second mode, which is a local area network, where the individual tracking units may communicate with each other. Another disclosure, the U.S. application Ser. No. 11/242,428 (Publication date Mar. 29, 2007) in essence describes a system and a method for locating a wireless device in a wireless communication system. Another invention, the U.S. Pat. No 8,432,273 B2 (Publication date Apr. 30, 2013) in essence describes method and apparatus for providing device recovery assistance that is also capable of device location tracking

The disclosed invention is aiming to incorporate into the design of an electronic system a set of persistent controls facilitating Location-Based Services at a fundamental level. The referenced prior art is limited in addressing the needs of secure and persistent enablement of LBS for local and remote use.

### DESCRIPTION OF THE INVENTION

The following description and the referrals to the accompanying drawings show, by way of illustration, specific details and aspects of this disclosure in which the invention may be practiced. The word “exemplary” is used herein to mean “serving as an example, instance, or illustration”. Any aspect of this disclosure described herein is not necessarily to be construed as preferred or advantageous over other aspects of this disclosure or designs unless expressly stated. The term “location-based data” shall mean to include any location related data and metadata of any electronic device, any derivative data and metadata, including generation of any data not containing location information but being a partial or full result of location-based data, any related instructions and commands, as well as raw digitalized measurements produced by sensor means for computing an electronic device location and/or position. The term “operating system” may be understood as an independent program of instructions and shall furthermore include software that operates in the operating system or coupled with the independent program of instructions. For the purpose of illustrating this invention, the term “power source” shall mean to also include: an electrical battery, power grid, solar, piezo, wind, or chemically generated electrical power, or any other source of power. A “circuit” (or “circuitry”) may be understood as any kind of logic implementing entity, which may be hardware (in some exemplary embodiment, including silicon), software, firmware, or any combination thereof. Thus, a “circuit” may be a hard-wired logic circuit or a programmable logic circuit such as a programmable processor, e.g. a microprocessor. A “processor” may also be understood as any number of processor cores. A “circuit” may also be software being implemented or executed by a processor, e.g. any kind of computer program. Any other kind of implementation of the respective functions described herein may also be understood as a “circuit” or “circuitry”. The terms “coupling” or “connection” are intended to include a direct “coupling” or direct “connection” as well as an indirect “coupling” or indirect “connection” respectively. A “network” may be understood any physical and logical network, including Internet network, local network, wireless or wired network, etc. A “website” may be understood as a data storage medium, a server, a gateway, a proxy, a database, a peered electronic device, a display, a printer, a controller, a device communicating over wired or wireless network, a device having electronic circuitry.

In the following description, numerous specific details such as logic implementations, means to specify operands, resource implementations, types and interrelationships of system components, and logic choices may be set forth in order to provide a more thorough understanding of the present disclosure. It will be appreciated, however, by one skilled in the art that embodiments of the disclosure may be practiced without such specific details. In other instances, control structures, circuits, and full software instruction sequences may have not been shown in order not to obscure the disclosure.

The present invention provides an improved method and apparatus for facilitating persistent Location-Based Services. According to one aspect of the present invention, there is a method and apparatus for facilitating acquisition and transmission of location-based data out-of-band, regardless of the operability of the main electronic circuitry of an electronic device. In one exemplary embodiment, the method and apparatus includes among other constituents: an operating system responsible for operating an electronic device (in-band operating system); and an operating system (out-of-band operating system) that works independent of the in-band operating system. Such out-of-band operating system communicates with a location detection system operably and/or communicatively coupled with the electronic device. Such out-of-band operating system communicates with network access software that is independent of the in-band operating system. The aforementioned network access software, in one exemplary embodiment, may access a communication network to transmit location-based data to a remote computer or a website, including transmitting such data over the Internet. In another exemplary embodiment, such out-of-band operating system communicates with a memory media operably and/or communicatively coupled with the electronic device. In another exemplary embodiment, the out-of-band operating system can store location-based data in a nonvolatile secure memory operably coupled with the electronic device. In another exemplary embodiment, the out-of-band operating system may communicate with the in-band operating system providing location-based data to the in-band operating system.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

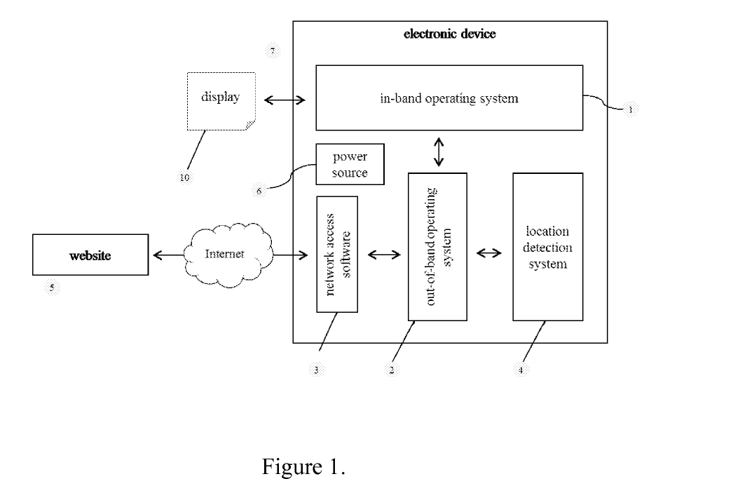

FIG. 1 illustrates an exemplary embodiment of the apparatus that facilitates persistent LBS, where in one embodiment such apparatus has network access software 3 and an out-of-band operating system 2 that is separate from an in-band operating system 1 that operates the electronic device 7, and such out-of-band operating system 2 and/or network access software 3 is integrated into the circuitry of the electronic device 7.

FIG. 1 further illustrates an exemplary embodiment of the method and apparatus that facilitates persistent LBS, where out-of-band operating system 2 communicates with location detection system 4, receiving location-based data and transmitting such data to the network access software 3. Network access software 3 then transmits location-based data to a website 5. In another exemplary embodiment, the out-of-band operating system 2 communicates the location-based data to the in-band operating system 1. In another exemplary embodiment, the out-of-band operating system 2 communicates the location-based data to the in-band operating system 1, and the in-band operating system 1 displays such data or its derivative data in the appropriate presentation on a coupled display 10. In one exemplary embodiment, the circuitry that operates the network access software 3 and/or the out-of-band operating system 2 is powered by the same power source that powers the electronic device 7. In another exemplary embodiment, the location detection system 4 is covertly installed on the electronic device 7 and operates only via an out-of-band operating system 2 and an out-of-band communication channel.

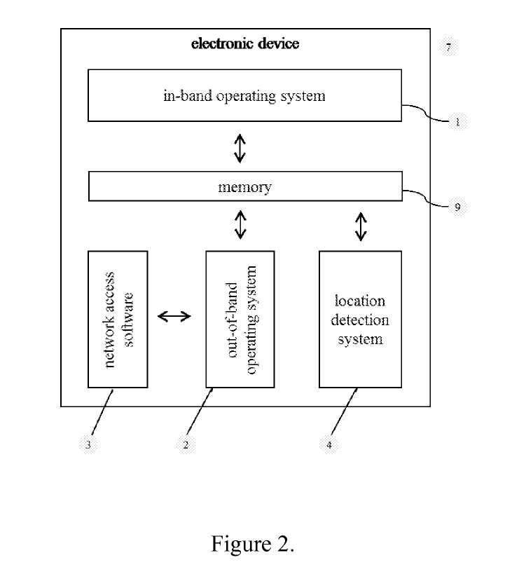

FIG. 2 illustrates an exemplary embodiment of the disclosed invention, where the location detection system 4, out-of-band operating system 2, and in-band operating system 1 read and write data into a memory 9 buffer, where such data may include location-based data. In one exemplary embodiment, the location detection system 4 stores location-based data in the memory 9, and in-band operating system 1 and out-of-band operating system 2 access such location data independent of each other. In another exemplary embodiment, such data may be stored in a protected segment of a memory 9 to be accessible only by the out-of-band operating system 2. Such memory 9 could be transitory, non-transitory, volatile or nonvolatile or any combination thereof, or any other electronic memory on any physical medium.

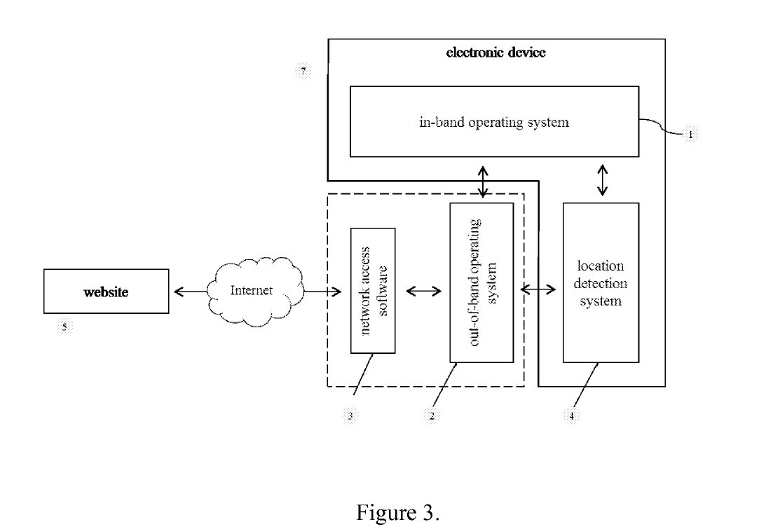

FIG. 3 illustrates an exemplary embodiment of the disclosed invention, where the network access software 3 and/or the out-of-band operating system 2, being communicatively coupled with at least one interface of the electronic device 7 in a way that makes possible operating independently of the in-band operating system 1, and not being part of the integrated electronics of the electronic device 7. Therefore it is possible to disengage and/or remove the media carrying the network access software 3 and/or the out-of-band operating system 2 from the electronic device 7. In another exemplary embodiment, the location detection system 4 may be operably coupled with the electronic device 7, for example, be embedded into the silicon of the electronic device, or in another example be integrated with the electronic circuitry of the electronic device; therefore not being detachable from the electronic device.

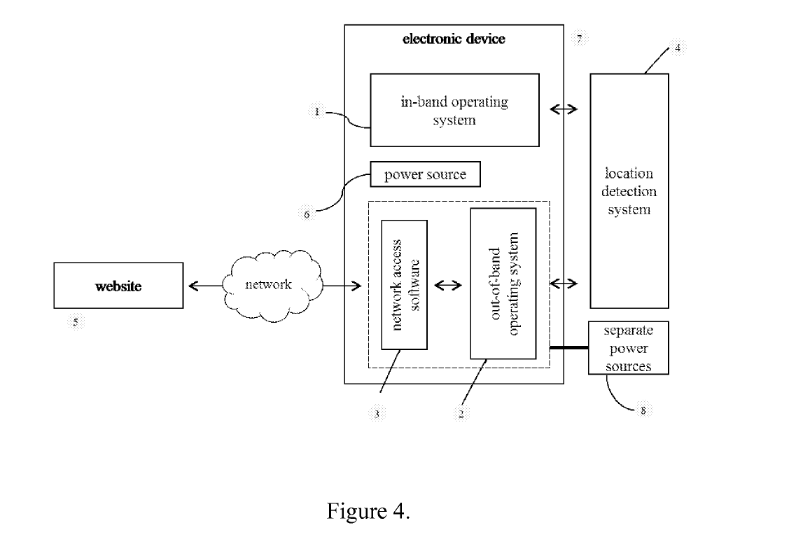

FIG. 4 illustrates an exemplary embodiment of the disclosed invention, where the circuitry that operates the network access software 3 and/or the out-of-band operating system 2 is powered from a separate power source 8 than the electronic device 7. In another exemplary embodiment, the location detection system 4 may be communicatively coupled with the electronic device 7 in a way that allows the in-band operating system 1 and the out-of-band operating system 2 to exchange data with the location detection system 4 while it is communicatively coupled with the electronic device. Therefor the location detection system 4 can be detached and uncoupled with the electronic device 7.

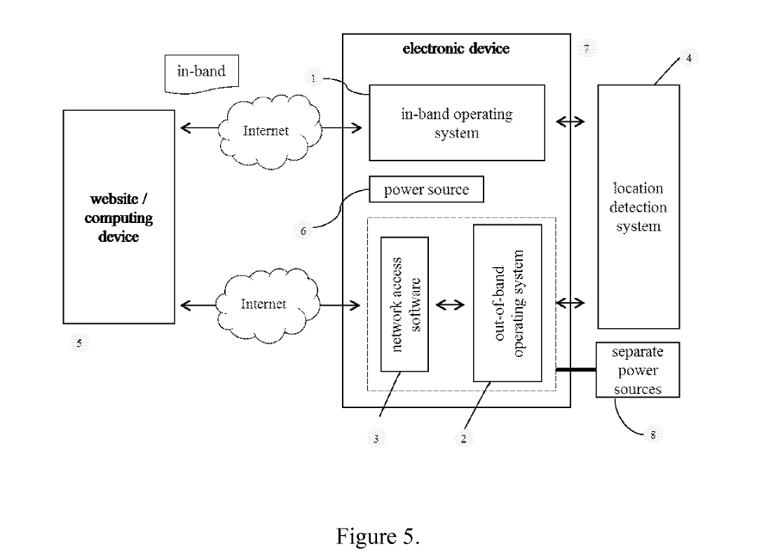

FIG. 5 illustrates an exemplary embodiment of the disclosed invention where the network access software 3 and the in-band operating system 1 communicate and exchange location-based data concurrently or consecutively with a particular website 5 over the Internet to provide in-band and out-of-band location-based data.

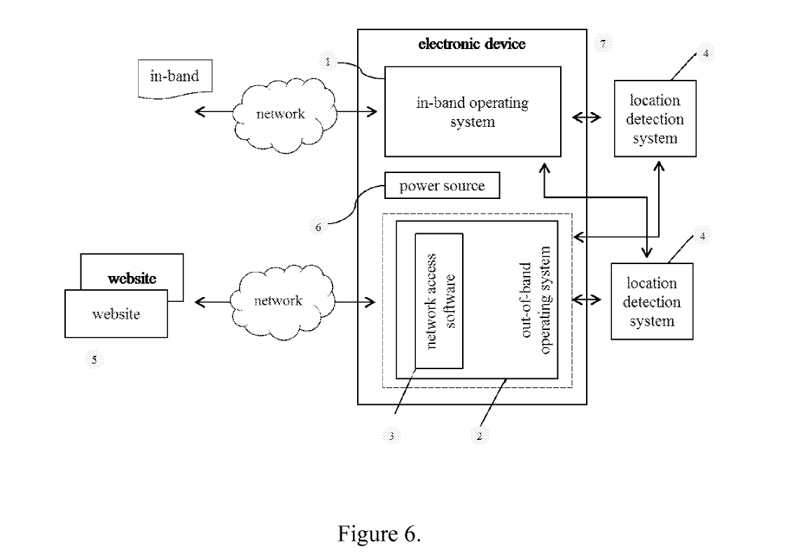

FIG. 6 illustrates an exemplary embodiment of the disclosed invention where the network access software 3 is a part of or operates in the out-of-band operating system 2. In another exemplary embodiment of the disclosed invention, the network access software 3 may connect consecutively or concurrently and exchange location-based data with plurality of websites 5. In other exemplary embodiment, the plurality of location detection systems 4 may exchange data with the in-band 1 and the out-of-band operating system 2 concurrently or consecutively.

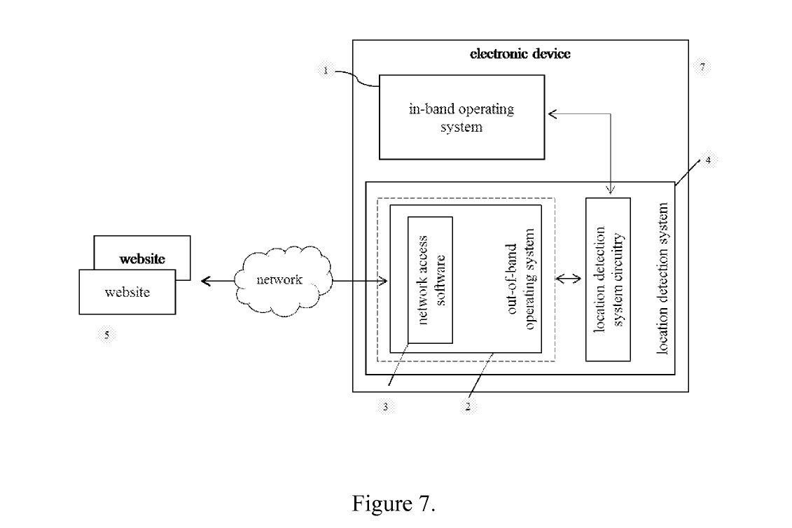

FIG. 7 illustrates an exemplary embodiment of the disclosed invention, where the out-of-band operating system 2 and the network access software 3 are coupled with the location detection system 4.

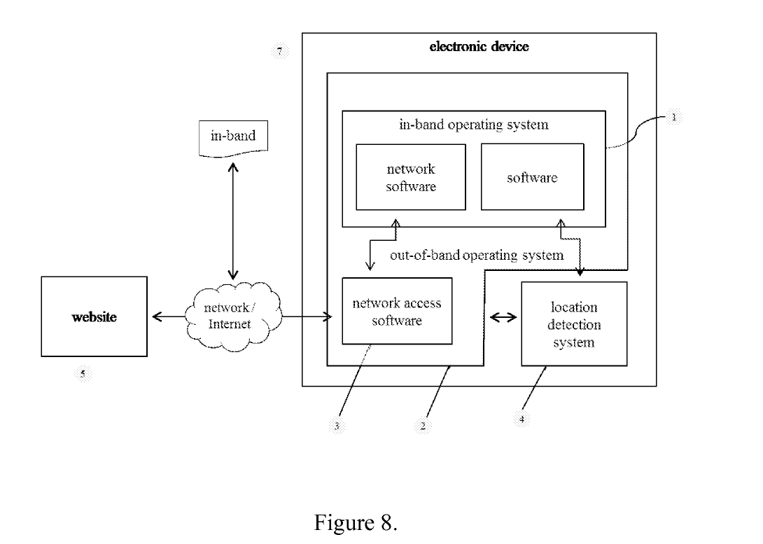

FIG. 8 illustrates an exemplary embodiment of the disclosed invention, where the out-of-band operating system 2 hosts the virtualized in-band operating system 1 that operates the electronic device 7.

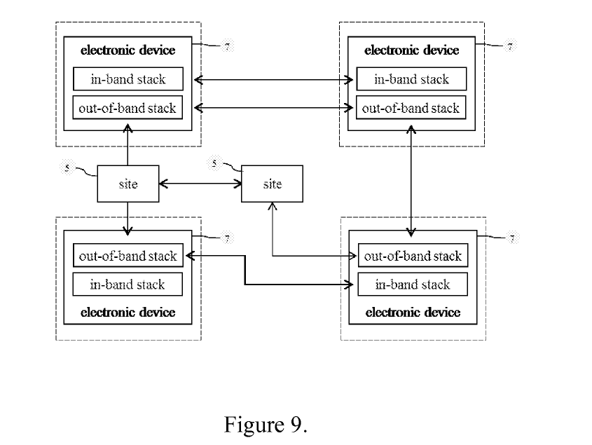

FIG. 9 illustrates an exemplary embodiment of the disclosed invention that exemplifies, among other subject matter, several network communicational arrangements between electronic devices 7 and websites 5 via in-band and out-of-band channels.

One exemplary embodiment includes a method and apparatus of providing persistent out-of-band geographic location information of an electronic device. An electronic device is equipped with a GPS receiver embedded into the device circuitry and an out-of-band stack that is independent from the in-band stack, as exemplified in this disclosure. Upon a certain command received from a server, for example in an event of device loss or theft, and/or in the event if the device geographic location information was not received within a set timeframe, and/or in the event of an alert received from the device in-band stack, and/or upon any other condition or the lack thereof, the out of band stack on the device activates a GPS receiver and transmits the geographical location information to the server. The server then stores this information in a database and visualizes this information, for example, on an electronic map upon a request of the operating personnel. In another exemplary embodiment, the out-of-band stack may initialize GPS upon a certain trigger, such as a signal from an accelerometer sensor indicative of the device movement or an impact. In another exemplary embodiment, the out-of-band stack may initialize GPS periodically, on schedule, to send geographical location updates to a remote server. In another exemplary embodiment, the out-of-band stack may initialize GPS upon a certain unique set of conditions, such as receiving a triggering data form the in-band operating system and upon receiving a certain combination of parameters from plurality of sensors coupled with the electronic device. In another exemplary embodiment, the out-of-band stack may transmit to a remote server identifying indicia of the electronic device at the time of transmission of geographical location information or at any other time. In another exemplary embodiment, the out-of-band stack may transmit to a remote server identifying indicia of the electronic device and transmit geographic location information, in one exemplary embodiment, after receiving a request from the remote server or not receiving a request, or upon some other condition.

One exemplary embodiment includes a method and apparatus of providing persistent out-of-band geographic location information of an electronic device, in addition to the location information transmitted by the in-band stack of such device. An electronic device is equipped with a cellular transceiver communicatively coupled with the electronic device and an out-of-band stack, as exemplified in this disclosure. A transceiver receives information from broadcasting cellular towers, containing IDs of such towers and sensing the strength of signal of each tower. The transceiver communicates with the in-band operating system allowing to compute an approximate electronic device location, if the geographic coordinates of cellular towers are known. The in-band operating system transmits such location information to a remote server. In addition, the out-of-band operating system communicates with such cellular transceiver receiving, in one exemplary embodiment, IDs of such cellular towers and signal strength information and, in one exemplary embodiment, transmits such information to a remote server out-of-band. The server then computes the electronic device geographical location information and stores it in a database. In another exemplary embodiment, the out-of-band operating system computes an approximate electronic device location, if the geographic coordinates of such cellular towers are known. The out-of-band operating system then transmits such location information to a remote server using the network access software.

One exemplary embodiment includes a method of transmitting to a remote server at a set time interval, the geographic location information of an electronic device out-of-band, using the independent network access software. If the electronic device malfunctions, for example, due to a virus attack or physical commencement of hostilities, and the in-band operating system is not able to communicate with the server and transmit location data, the out-of-band stack may be able to communicate with the server and transmit the geographic location information being independent of the infected or inoperable in-band stack.

One exemplary embodiment includes a method and apparatus of providing persistent out-of-band geographic location information of an electronic device. The method and apparatus include an out-of-band stack able of sensing presence of a communication network and upon detecting network availability, obtaining geographic location information from a location detection system and transmitting such information to a remote server. In another exemplary embodiment, an out-of-band stack may periodically or upon a certain event trigger, obtain geographical location information from a location detection system and store such information in the memory coupled with the electronic device. In another exemplary embodiment, an out-of-band stack may store historic records of geographic location information in the memory coupled with the electronic device and transmit all or part of such information upon a certain condition. In another exemplary embodiment, the out-of-band stack may store historic records of geographic location information in the memory coupled with the electronic device and transmit all or part of such information upon detection of network availability.

One exemplary embodiment includes a method and apparatus of providing persistent out-of-band geographic location information of an electronic device. The method and apparatus include an out-of-band stack that communicates with a location detection system to obtain geographical location information and transmits such information to an in-band operating system. In another exemplary embodiment, the out-of-band stack may store historic records of geographic location information in the protected memory coupled with the electronic device, inaccessible by the in-band operating system, and upon a certain event communicate all or part of such information to an in-band operating system.

One exemplary embodiment includes a method and apparatus of providing persistent out-of-band geographic location information of an electronic device. The method and apparatus include an out-of-band stack that communicates with a location detection system, obtaining geographic location information, executing a certain logic pertaining to such information and, in one exemplary embodiment, generating an alert message and transmitting such alert message that may or may not contain geographical location information to a remote server or an in-band operating system. In one exemplary embodiment, such alert message may contain electronic device identifying indicia, and in another exemplary embodiment, contain a message code, and in another exemplary embodiment, not contain any location-based data, in another exemplary embodiment, contain information indicating directly or indirectly where the geographic location information may be obtained or pointing to location-based data, in another exemplary embodiment, such alert message may be transmitted using SMS or broadcasting, multicasting, publish/subscribe, and any other communication protocol and system.

One exemplary embodiment includes a method and apparatus that allows persistent out-of-band communication between plurality of electronic devices, exchanging geographic location information. One exemplary embodiment includes exchanging information with plurality of websites. In one exemplary embodiment, such information exchange can be triggered by a push and/or an SMS message received by in-band and/or out-of-band stacks. In one exemplary embodiment, the transmission of geographic location information can be originating from an out-of-band stack of an electronic device, where the receiver is an in-band stack of the same or another electronic device and vice versa. In one exemplary embodiment, the information transmission can be pear to pear. In one exemplary embodiment, the information transmission can be done via secure or unsecure network tunnel. In one exemplary embodiment, the information transmission can be done via non-TCP/IP communication. In one exemplary embodiment, the information transmission can be done via wireless communication means. In another exemplary embodiment, the information transmission can be bidirectional. In another exemplary embodiment, the information can be broadcasted to plurality of electronic devices. In another exemplary embodiment, an electronic device may receive out-of-band geographic location information of another device and re-transmit such information over the network accordingly. In another exemplary embodiment, an electronic device may receive in-band geographic location information of another device and re-transmit such information via out-of-band channel accordingly. In another exemplary embodiment, plurality of electronic devices may receive out-of-band geographic location information from plurality of other electronic devices and multi-cast such information accordingly. In another exemplary embodiment, the location-based data can be transmitted from an electronic device using both in-band and out-of-band stack consecutively or concurrently.

One exemplary embodiment includes a method and apparatus of providing persistent out-of-band geographic location information of an electronic device. The method and apparatus include an out-of-band stack that communicates with plurality of location detection systems of various types communicatively and/or operably coupled with the electronic device, for example, GPS, Inertial Navigation System (INS), and VOR obtaining location-based data. In another exemplary embodiment, out-of-band stack that communicates with plurality of location detection systems, obtains location-based data and performs certain computations using that data. In another exemplary embodiment, out-of-band stack that communicates with plurality of location detection systems, obtains location-based data, performs certain computations using that data, and transmits location-based related data to a webserver over the Internet, or if the network connection is unavailable stores such data in the memory coupled with the electronic device. In another exemplary embodiment, such computations may include the determining of most relevant or resulting geographical location information from plurality of location detection systems and/or sensors. In another exemplary embodiment, such computations may include location-based data received from the in-band operating system. In another exemplary embodiment, out-of-band stack initiates acquisition and, in another embodiment, transmission of geographical location information to a remote website upon detecting a connection with at least one location detection system.

One exemplary embodiment includes a method and a system of providing persistent out-of-band geographic location information of an electronic device. The method and a system include an electronic device equipped with Intel® Active Management Technology (AMT) and having out-of-band (OOB) communication capabilities, where such AMT is communicatively and/or operably coupled, in one exemplary embodiment, with GPS or cellular receiver, and being able to acquire location-based data; and in another exemplary embodiment, being able to transmit such data to a remote server, and/or store such data in a memory communicatively and/or operably coupled with the electronic device, and/or transmit such data to an in-band operating system of the electronic device.

One exemplary embodiment includes a method and a system of providing persistent out-of-band geographic location information of an electronic device. The method and a system include an electronic device equipped with manageability engine (ME), where such ME is communicatively and/or operably coupled, in one exemplary embodiment, with GPS or cellular receiver, and being able to acquire location-based data; and in another exemplary embodiment being able to transmit such data to a remote server, and/or store such data in a memory operably and/or communicatively coupled with the electronic device, and/or transmit such data to an in-band operating system of the electronic device.

One exemplary embodiment includes a method and apparatus of providing persistent out-of-band geographic location information of an electronic device. The method and apparatus include a processor coupled with an electronic device that may execute instructions and boot an in-band operating system. Upon a condition, such as inability to boot an in-band operating system, such processor may execute instructions and boot an out-of-band-operating system.

One exemplary embodiment includes an apparatus of providing persistent out-of-band geographic location information of an electronic device. The apparatus include circuitry being implemented as System on Chip (SoC), where among other components there is an in-band processor that executes instructions of an in-band operating system, and an out-of-band processor that executes instructions of an out-of-band operating system, the out-of-band operating system accesses a network using network access software and SoC communication interface, and both in-band operating system and out-of-band operating system are coupled with GPS and cellular transceivers located or connected to the SoC.

One exemplary embodiment includes an apparatus of providing persistent out-of-band geographic location information of an electronic device. The apparatus include circuitry being implemented where there is a location detection system that is coupled with an out-of-band operating system and network access software, where such out-of-band stack is integrated with circuitry of the location detection system, and such location detection system is operably and/or communicatively coupled with an electronic device.

One exemplary embodiment includes an apparatus of providing persistent out-of-band geographic location information of an electronic device, where such electronic device is a location detection system having an in-band processor that operates the electronic device; and an out-of-band processor operating independently from the in-band processor that receives location-based data originated from at least one location sensor, and a communications interface coupled with an out-of-band processor.

One exemplary embodiment includes an apparatus of providing persistent out-of-band geographic location information of an electronic device, where such electronic device is a location detection system having an in-band processor, and a communications interface operably coupled with such in-band processor, and an in-band operating system, and an out-of-band operating system, which is coupled, in one exemplary embodiment, with a radar-based location detection sensor.

One exemplary embodiment includes a method and apparatus of providing persistent out-of-band geographic location information of a personal computing device, where such computing device is equipped with manageability engine (ME) and/or Intel® Active Management Technology (AMT). Further, such AMT may communicate using an out-of-band channel over a network. Such AMT and/or ME is coupled with a cellular and/or satellite location detection systems in a way that it may be able to obtain location-based data and store such data locally and/or transmit it over a network. In one exemplary embodiment, such network may be the Internet.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. A method and apparatus for providing geographical location information of an electronic device where:
at least one electronic device having at least one processor that operates the electronic device (in-band processor); and
a communications interface operably coupled with at least one in-band processor; and
at least one program of instructions or an operating system for operating the electronic device (in-band operating system), and an independent program of instructions or an operating system (out-of-band operating system), which is coupled with at least one of: GPS, GLONASS, Galileo, COMPASS, satellite-based, telemetry-based, inertia-based, VOR-based, mapping-based, environmental conditions-based, celestial-based, chronometer-based, gyro-based, magnetic field-based, radar-based, optical-based, cellular network-based, cellular device-based location detection system and any combination thereof (location detection system).

2. A method and apparatus according to claim 1, having network access software that operates independently of the in-band operating system.

3. A method and apparatus according to claim 1, having network access software, which operates independently of the in-band operating system, and operably and/or communicatively coupled with the independent program of instructions or an operating system (out-of-band operating system).

4. A method and apparatus according to claim 1, having network access software, which operates independently of the in-band operating system, and accesses network to connect with at least one electronic device and/or at least one website, exchanging location-based data or metadata with at least one electronic device and/or at least one website.

5. A method and apparatus according to claim 1, wherein the out-of-band operating system stores location-based data or metadata in at least one of:
volatile, nonvolatile, transitory, non-transitory memory communicatively and/or operably coupled with the electronic device.

6. A method and apparatus according to claim 1, wherein the out-of-band operating system exchanges data or metadata with at least one location detection system, when at least one or all in-band processors, and/or at least one or all in-band operating systems are off, not fully operable, or malfunction.

7. A method and apparatus according to claim 1, having at least one radio device operably and/or communicatively coupled with the electronic device.

8. A method and apparatus according to claim 4, wherein the network access software communicates using an Out of Band (OOB) channel and/or wherein the network access software uses one of: DHCP and static IP.

9. A method and apparatus according to claims 4, where there is a transmission of data that allows identifying an electronic device and/or at least one electronic device user and/or where there is a transmission of location-based data or metadata without transmitting the electronic device unique identifying indicia and/or information that uniquely identifies at least one electronic device user.

10. A method and apparatus according to claim 4, where there is a transmission of data or metadata related to at least one event generated on an electronic device as a result of location-based data or metadata, and/or where there is a transmission of data or metadata produced as a result of processing location-based data or metadata, and/or where there is a transmission of location-based data or metadata concurrently or consecutively with the exchange of location-based data or metadata produced by the in-band operating system.

11. A method and apparatus according to claim 4, where there is a transmission of location-based data or metadata where at least one of: on schedule, upon an event, upon a command, continuously and/or persistently.

12. A method and apparatus according to claim 4, wherein the network access software transmits data that may identify location where location-based data or metadata of the electronic device may be obtained.

13. A method and apparatus according to claim 4, wherein the network access software communicates using at least one of: HTTP, FTP, SOCKS, TLS, SSL, VPN, SMS, MMS, Ethernet/IP, PROFIBUS, PROFINET, DeviceNet, CAN, AFDX, ARINC, TTP, NMEA, LWE, non-TCP/IP protocols, and protocols capable of at least one: multiple recipient, multicast, broadcast addressing, tunneling protocols, pear to pear communication protocols, wireless communication protocols, publish/subscribe protocols, and/or wherein the network access software includes at least one of: a LAN driver, a WAN driver, a WWAN driver, a TCP/IP stack, an HTTP stack, a UDP stack, and network security software.

14. A method and apparatus according to claim 1, wherein the out-of-band operating system exchanges data with at least one location detection system on schedule, upon an event, a command, or continuously.

15. A method and apparatus according to claim 1, where there is at least one code instruction executed or procedure performed on the electronic device as a result of exchanging data between the out-of-band operating system and at least one location detection system, and/or where there is at least one event generated on the electronic device as a result of transmitting data between the out-of-band operating system and at least one location detection system.

16. A method and apparatus according to claim 1, where there is volatile and/or nonvolatile memory operably and/or communicatively coupled with the electronic device that is accessed at least once as a result of transmitting data between the out-of-band operating system and at least one location detection system, and/or where there is a transmission of data with the network access software that is a result of transmitting data between the out-of-band operating system and at least one location detection system.

17. A method and apparatus according to claim 1, where there is a transmission of location-based data or metadata between the out-of-band operating system and at least one in-band operating system.

18. A method and apparatus according to claim 1, wherein the out-of-band operating system and/or software executable by such out-of-band operating system is provided from one or more of: a boot disc, a hidden partition in a hard disc drive, volatile and non-volatile data storage media operably and/or communicatively coupled with the electronic device, a protected memory that in-band operating system does not access, a protected partition, a BIOS partition, a remote network location, a portable device.

19. A method and apparatus according to claim 1, wherein the out-of-band operating system is executed by at least one service processor (out-of-band processor) communicatively and/or operably coupled with the electronic device.

20. A method and apparatus according to claim 1, wherein the out-of-band operating system is executed by at least one in-band processor.

21. A method and apparatus according to claim 1, wherein the out-of-band operating system and at least one in-band operating system may be executed by at least one processor coupled with the electronic device.

22. An method and apparatus according to claim 1, wherein at least one in-band operating system works in the virtualization environment where the host is the out-of-band operating system.

23. A method and apparatus according to claim 1, wherein the location-based data or metadata and/or encryption key data is transmitted between at least one Trusted Platform Module (TPM), and/or at least one protected memory operably and/or communicatively coupled with the electronic device.

24. A method and apparatus according to claim 1, wherein the location detection system comprises of at least one of: terrestrial radio-based positioning, wireless network-based positioning, cellular network-based positioning, positioning using radio module, sensor-based positioning, IP trace-route-based positioning, cell ID-based positioning, caller ID-based positioning, low frequency radio-based positioning, ultrasound-based positioning, outdoor location detection system.

25. A method and apparatus according to claim 1, wherein the out-of-band operating system may be integrated into a circuitry of a location detection system.

26. A method and apparatus according to claim 1, wherein a location detection system operates covertly and/or stealthily on an electronic device, and/or out-of-band operating system, and/or network access software operate covertly and/or stealthily on an electronic device.

27. A system and method for providing geographic location information of an electronic device, where at least one electronic device having:
at least one in-band processor that operates electronic device; and
at least one out-of-band processor operating independently from the in-band processor that receives location-based data originated from at least one of:
GPS, GLONASS, Galileo, COMPASS, satellite-based, telemetry-based, inertia-based, VOR-based, mapping-based, celestial-based, environmental conditions-based, time-based, gyro-based, magnetic field-based, radar-based, optical-based, cellular network-based, cellular device-based location detection system and any combination thereof (location detection system); and
a communications interface coupled with an out-of-band processor.

28. A system and method according to claim 27, wherein such communications interface transmits location-based data to at least one website and/or at least one computing device over a network.

29. A system and method according to claim 27, wherein at least code instruction is executed by an out-of-band processor of writing or reading location-based data or metadata into at least one of: volatile, nonvolatile, transitory, non-transitory memory communicatively and/or operably coupled with the electronic device.

30. A system and method according to claim 27, wherein a location detection system comprises of at least one of: terrestrial radio-based positioning, wireless network-based positioning, cellular network-based positioning, positioning using radio module, sensor-based positioning, IP trace-route-based positioning, cell ID-based positioning, caller ID-based positioning, low frequency radio-based positioning, ultrasound-based positioning, outdoor location detection system.

31. A system and method according to claim 27, where at least one out-of-band processor being the active management technology processor or executes at least one code instruction of the active management technology, such as Intel® Active Management Technology (AMT).

32. A system and method according to claim 27, where at least one out-of-band processor being operably and/or communicatively coupled with manageability engine (ME), or being a processor of the ME, or executing at least one code instruction of the ME.

33. A system and method according to claim 27, wherein the location detection system is operably and/or communicatively coupled with the out-of-band processor.

34. A system and method for providing geographic location information of an electronic device, where at least one electronic device having:
active management technology, such as Intel® Active Management Technology (AMT); and/or manageability engine (ME); and
such AMT and/or ME receives location-based data originated from at least one of: GPS, GLONASS, Galileo, COMPASS, satellite-based, telemetry-based, inertia-based, VOR-based, mapping-based, celestial-based, environmental conditions-based, time-based, gyro-based, magnetic field-based, radar-based, optical-based, cellular network-based, cellular device-based location detection system and any combination thereof (location detection system).

35. A system and method according to claim 34, wherein a location detection system comprises of at least one of: terrestrial radio-based positioning, wireless network-based positioning, cellular network-based positioning, positioning using radio module, sensor-based positioning, IP trace-route-based positioning, cell ID-based positioning, caller ID-based positioning, low frequency radio-based positioning, ultrasound-based positioning, outdoor location detection system.

36. A system and method according to claim 34, wherein such AMT and/or ME is able to communicate over a network using OOB channel.
